(19) United States
(12) Patent Application Publication
(10) Pub. No.: US 2017/0058936 A1
(43) Pub. Date: Mar. 2, 2017

(54) WELD NUT

(71) Applicants: Hyundai Motor Company, Seoul (KR); Kia Motors Corporation, Seoul (KR); Sungwoo Hittech Co., LTD, Busan (KR); Samjin Jeonggong Co., LTD., Jeollabuk-do (KR)

(72) Inventors: Min Uke Han, Gwangmyeong (KR); Ki Sung Nam, Busan (KR); Moon Soo Kim, Jeollabuk-do (KR); Mun Yong Lee, Busan (KR)

(21) Appl. No.: 14/941,615

(22) Filed: Nov. 15, 2015

(30) Foreign Application Priority Data
Aug. 28, 2015 (KR) 10-2015-0121849

(51) Int. Cl. F16B 37/06

(52) U.S. Cl. CPC F16B 37/061

(57) ABSTRACT

A weld nut is provided and is welded to a base material through a nut insertion aperture formed within the base material. The weld nut includes a nut body that forms an appearance of a weld nut, and an insertion component that is formed to integrally protrude from the first surface of the nut body and inserted into the nut insertion aperture. Additionally, a bolt fastening aperture is formed to penetrate through the center of the nut body together with the insertion component.

### CROSS-REFERENCE TO RELATED APPLICATION

This application claims priority to and the benefit of Korean Patent Application No. 10-2015-0121849 filed in the Korean Intellectual Property Office on Aug. 28, 2015, the entire contents of which are incorporated herein by reference.

### BACKGROUND

(a) Field of the Invention

The present invention relates to a weld nut, and more particularly, to a weld nut that prevents deterioration in weldability caused by a hardness difference between a base material and the weld nut and an alumina silicon (Al—Si) coating layer formed on a surface of the base material, during welding the weld nut to a hot stamping molded article of high tensile steel.

(b) Description of the Related Art

Recently, automotive industry trends include reducing the fuel consumption of a vehicle, and research into new molding techniques and a high strength and ultralight materials that simultaneously satisfies hardness and lightness criteria. As a part of the recent research and development trends, a hot stamping technology, which includes a hot press molding technology using a boron steel plate, has actively been researched.

For example, the hot stamping technology includes a molding technology of manufacturing a high strength component by heating the boron steel plate at an appropriate temperature (e.g. about 900° C.) to be molded within a press mold and then rapidly cooling the boron steel plate. The boron steel plate is applied to a steel plate that includes the addition of a small amount of boron (B). The boron in austenite grain boundary under a condition of the appropriate temperature is segregated to an atom state to decrease free energy of the austenite grain boundary. Additionally a nucleation of pro-eutectoid ferrite is suppressed to significantly improve hardenability of steel (e.g., the ability of steel hardened by Martensite Formation, at the time of quenching).

Unlike an existing molding method that uses the high strength steel, a hot stamping molding utilizes the above-mentioned boron steel plate. For example a molded article of a Martensite structure having high tensile strength (e.g., about 1300 to 1600 MPa) is obtained by austenitizing the boron steel plate of a ferrite structure having tensile strength of 500 to 800 MPa before the molding at a high temperature of 900° C. or more. Additionally a high temperature molding for the boron steel plate is performed and then the boron steel plate is rapidly cooled.

Further, the hot stamping molded article has strength four to five times greater than that of a part of a general steel plate and may reduce weight up to 40% at maximum as compared to existing weight. The hot stamping molded article may simultaneously improve vehicle weight and the strength of a vehicle body. However, when the hot stamping molded article is intended to be welded to a weld nut to connect the hot stamping molded article to another part, it may be difficult to melt two materials simultaneously. For example, a hardness difference between a base material, which is the hot stamping molded article and the weld nut may be problematic. In other words, a welding condition considering hardness of the base material causes deformation of the weld nut and a welding condition considering hardness of the weld nut does not melt the base material of high hardness. Accordingly, the welded portion of the nut may be separated from the base material during bolting.

Prior remedies, according to the related art, include utilizing a worker to additionally perform carbon dioxide (CO₂) welding, however, this solution increases the complexity and makes it difficult to obtain uniform welding quality. Additionally, an Al—Si coating layer is formed on a surface of the base material to prevent an oxidation film generated during a molding process due to characteristics of the hot stamping molding. However, the Al—Si coating layer deteriorates welding performance between the base material and the weld nut. For example, the Al—Si coating layer causes cracks, thereby deteriorating bonding strength of the welded portion of the weld nut.

The above information disclosed in this section is intended merely to aid in the understanding of the background of the invention and therefore it may contain information that does not form the prior art that is already known in this country to a person of ordinary skill in the art

### SUMMARY

The present invention provides a weld nut that may enhance uniform welding quality to maintain bonding strength of a welded portion for tightening torque. In particular, a predetermined portion of an insertion component may be inserted into a nut insertion aperture formed within a base material. In other words, deterioration in weldability attributed to a hardness difference between the base material and the weld nut and an Al—Si coating layer formed on a surface of the base material may be prevented. Accordingly, while welding the weld nut to a hot stamping molded article of high tensile steel and spatter may be reduced.

In one aspect, an exemplary embodiment provides a weld nut that may be welded (e.g., coupled) to a base material through a nut insertion aperture formed within the base material. Furthermore, a nut body may form an appearance, (e.g., an external shape of the weld nut) an insertion component may be integrally formed to protrude from a first surface of the nut body and disposed (e.g. inserted) into the nut insertion aperture and a bolt fastening aperture may be formed to extend (e.g., penetrate) through the center of the nut body together with the insertion component.

The insertion component may be formed to protrude from the first surface of the nut body and may have a thickness less than a thickness of the base material. The insertion component may be formed in a polygonal shape (e.g., a circular shape or the like). Further, an exterior peripheral surface of a protruded first end of the insertion component may be formed to be rounded along a circumferential direction and a second end (e.g., opposite end) of the insertion component connected to the nut body may be formed to be slanted toward an exterior side of the nut body from the first end thereof.

Additionally, the bolt fastening aperture may be formed vertically (e.g., longitudinally) in a length direction of the nut body disposed at the center of the nut body based on a width direction of the nut body at the center of the insertion part. Further, a screw tap may be formed on an interior circumferential surface of the bolt fastening aperture. In some exemplary embodiments, the base material may be a hot stamping molded boron steel plate. The nut body may have an appearance formed in a polygonal shape (e.g., a circular shape).

### BRIEF DESCRIPTION OF THE DRAWINGS

The above and other features of the present disclosure will be apparent from the following detailed description when taken in conjunction with the accompanying drawings, in which:

FIG. 1 is an exemplary perspective view of a weld nut according to an exemplary embodiment of the present invention;

FIG. 2 is an exemplary rear perspective view of the weld nut according to the exemplary embodiment of the present invention;

FIG. 3 is an exemplary side view of the weld nut according to the exemplary embodiment of the present invention;

FIG. 4 is an exemplary cross-sectional view of the weld nut according to the exemplary embodiment of the present invention; and

FIG. 5 is an exemplary cross-sectional perspective view illustrating a figure that the weld nut according to the exemplary embodiment of the present invention is coupled to a base material.

### DESCRIPTION OF SYMBOLS

10: base material
12: nut insertion aperture
14: welded part
100: weld nut
110: nut body
120: insertion component
122: slanted surface
130: bolt fastening aperture

### DETAILED DESCRIPTION

Advantages and features of the invention and methods of accomplishing the same may be understood more readily by reference to the following detailed descriptions of exemplary embodiments and the accompanying drawings. While the invention will be described in conjunction with exemplary embodiments, it will be understood that present description is not intended to limit the invention to those exemplary embodiments. On the contrary, the invention is intended to cover not only the exemplary embodiments, but also various alternatives, modifications, equivalents and other embodiments, which may be included within the spirit and scope of the invention as defined by the appended claims.

The terminology used herein is for the purpose of describing particular embodiments only and is not intended to be limiting of the invention. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof. As used herein, the term “and/or” includes any and all combinations of one or more of the associated listed items. For example, in order to make the description of the present invention clear, unrelated parts are not shown and, the thicknesses of layers and regions are exaggerated for clarity. Further, when it is stated that a layer is “on” another layer or substrate, the layer may be directly on another layer or substrate or a third layer may be disposed therebetween.

Accordingly, the drawings and description are to be regarded as illustrative in nature and not restrictive. Like reference numerals designate like elements throughout the specification. Since sizes and thicknesses of the respective components shown in the drawings are arbitrarily shown for the convenience of explanation, the present invention is not necessarily limited to those shown in the drawings and thicknesses of several layers and regions are exaggerated for clarity.

It is understood that the term “vehicle” or “vehicular” or other similar term as used herein is inclusive of motor vehicles in general such as passenger automobiles including sports utility vehicles (SUV), buses, trucks, various commercial vehicles, watercraft including a variety of boats and ships, aircraft, and the like, and includes hybrid vehicles, electric vehicles, plug-in hybrid electric vehicles, hydrogen-powered vehicles and other alternative fuel vehicles (e.g. fuels derived from resources other than petroleum). As referred to herein, a hybrid vehicle is a vehicle that has two or more sources of power, for example both gasoline-powered and electric-powered vehicles.

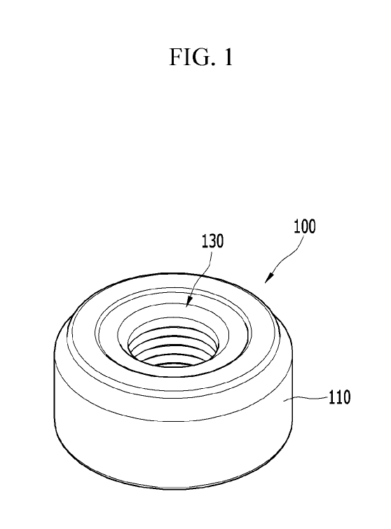

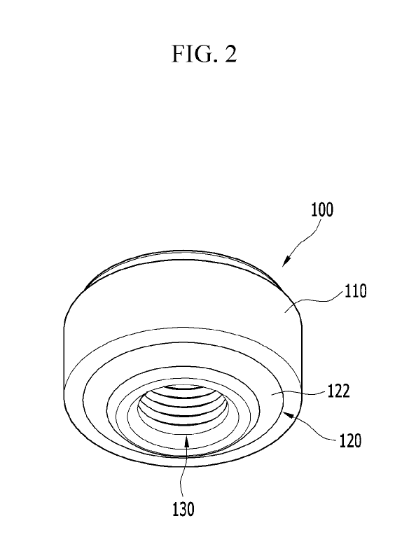

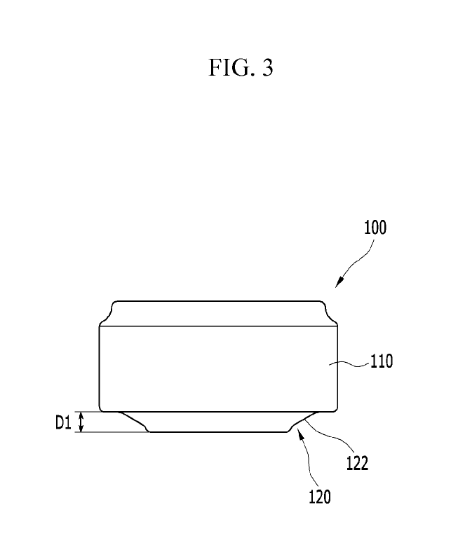

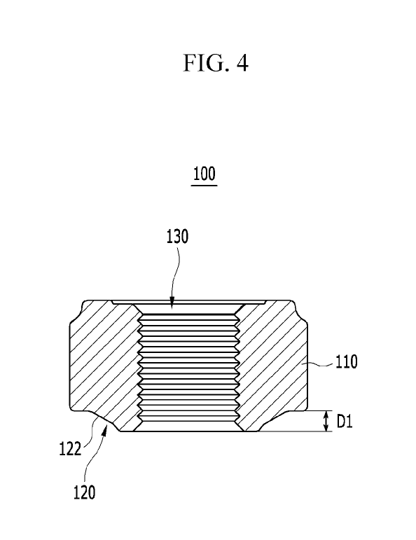

FIGS. 1 and 2 include an exemplary perspective view and an exemplary rear perspective view of a weld nut according to an exemplary embodiment. FIG. 3 is an exemplary side view of the weld nut according to the exemplary embodiment. FIG. 4 is an exemplary cross-sectional view of the weld nut according to the exemplary embodiment.

Referring to the drawings, a weld nut 100 according to an exemplary embodiment may secure uniform welding quality to maintain bonding strength of a welded portion for tightening torque. For example, a predetermined portion of an insertion component 120 may be disposed (e.g., inserted) into a nut insertion aperture 12 formed within a base material 10 to prevent deterioration in weldability caused by a hardness disparity between the base material 10 and the weld nut 100. Further, an Al—Si coating layer may be formed on a surface of the base material 10, while welding the weld nut 100 to a hot stamping molded article of high tensile steel, and may reduce spatter that occurs during the welding. In particular, the weld nut 100 may be welded through the nut insertion aperture 12 formed in the base material 10. The weld nut 100 may include a nut body 110, an insertion component 120, a bolt fastening aperture 120, as illustrated in FIGS. 1 to 4.

Furthermore, when the weld nut 100 is welded to the base material 10, a hot stamping molded boron steel plate of high tensile may be formed from the base material 10. Additionally, the nut insertion aperture 12 may be formed to have a substantially circular shape and may penetrate (e.g., extend) through the base material 10. In an exemplary embodiment, the nut body 110 may form an appearance of a weld nut. The nut body 110 may have an appearance formed in a polygonal shape (e.g., a circular shape).

The insertion component 120 may be formed to integrally protrude from the first surface of the nut body 110 directed to the nut insertion aperture 12 and may be inserted into the nut insertion aperture 12. The insertion component 120 may be formed to have a size that corresponds to the nut insertion aperture 12 at the center of the first surface of the nut body 110. Further a thickness D1 of the insertion component 120 may be formed to protrude (e.g., extend) from the first surface of the nut body 110 and may have a thickness (D1<D2) less than a thickness D2 of the base material 10. Additionally, the insertion component 120 may be formed in a shape that corresponds to a shape of the nut insertion aperture 12. For example the shape may be include a polygonal shape (e.g., a circular shape), and may be formed in the first surface of the nut body 110 by a forging molding.

Further, an exterior peripheral surface of the first end that includes an end portion protruding from the nut body 110 of the insertion component 120, may be formed to be rounded along a circumferential direction. For example, the insertion component 120 may be smoothly inserted into the nut insertion aperture 12. The second end of the insertion aperture 120 connected to the nut body 110 may be formed with a slanted surface 112 angled toward an exterior side of the nut body 110 from the protruded first end.

The bolt fastening aperture 130 may be formed to extend (e.g., penetrate) through the center of the nut body 110 together with the insertion component 120, and may be fastened with a bolt (not illustrated) to couple (e.g., connect or fasten) the insertion component to the weld nut 100. The bolt fastening aperture 130 may be formed vertically (e.g., in a length direction of the nut body 110) at the center of the nut body 110 based on a width direction of the nut body 110 at the center of the insertion component 120. Additionally, a screw tap may be formed on an interior circumferential surface thereof and a fastening component including the bolt may be fastened to the bolt fastening aperture 130 by a screw or any other fastening mechanism.

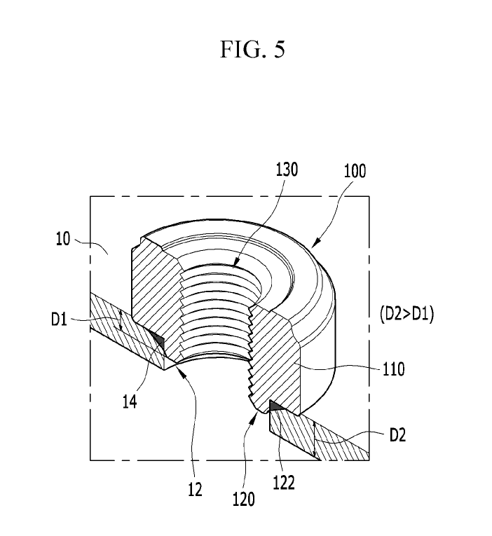

Hereinafter, a method of using the weld nut 100 according to an exemplary embodiment will be described with reference to FIG. 5. FIG. 5 is an exemplary cross-sectional perspective view illustrating a weld nut according to the exemplary embodiment coupled to a base material. For example, the weld nut 100 of the exemplary embodiment may be welded using a nut welder and a nut feeder that supplies the weld nut 100 to the nut welder. A user or a worker may insert the weld nut 100 supplied from the nut feeder into the nut insertion aperture 12. In particular, the weld nut 100 may be disposed to allow the insertion component 120 may be directed to a lower surface that corresponds to an upper portion of the nut insertion aperture 12, when the base material 10, (e.g., a vehicle body panel of a vehicle) is loaded on a lower holder of the nut welder. Thereafter, current may be applied for a predetermined time when the upper portion of the weld nut 100 is compressed to the base material 10 by descending an upper holder of the nut welder.

In particular, a corner portion of an upper end interior circumferential surface of the nut insertion aperture 12 contacts the slanted surface 122 of the insertion component 120. The slanted surface 122 may be melted by the heat generated by the applied current, such that the weld nut 100 is welded to the base material 10. In other words, when the insertion component 120 is inserted into the nut insertion aperture 12, the slanted surface 122 may contact the corner portion of the interior circumferential surface at the upper end of the nut insertion aperture 12.

Namely, the current may be applied for the predetermined time while maintaining the upper portion of the weld nut 100 compressed by the upper holder. Further, predetermined portions of the slanted surface 122 of the insertion component 120 and the upper end portion of the nut insertion aperture 12 may be melted simultaneously. Additionally, the weld nut 100 may be deposited when the first surface of the nut body 110, and the insertion component 120 and the slanted surface 122 are proximately positioned (e.g., closely adhered) to the nut insertion aperture 12 and the upper surface of the base material 10.

Thereafter, the upper holder may ascend and the weld nut 100 may include an increased melting area between the base material 10 and the weld nut 100 as compared to a general weld nut of the related art in which the insertion component 120 is not formed. Therefore, the deposition strength of the weld nut may be improved.

The insertion component 120 may be stably welded to the nut insertion aperture 12 through the slanted surface 122. Additionally, the weld nut 100 may secure deposition strength of the welded portion 14 by absorbing tightening torque for the nut insertion aperture 12. Further, uniform welding may be achieved without being adversely affected by the Al—Si coating layer formed on the surface of the base material 10 to prevent oxidation.

Therefore, when the weld nut 100 includes the welding performed with the predetermined portion of the insertion component 120 disposed into the nut insertion aperture 12 formed within the base material 10 the weldability may be improved. For example, the welding technique may prevent deterioration in weldability caused by the hardness disparity between the base material 10 and the weld nut 100. Further, the Al—Si coating layer formed on the surface of the base material 10 may prevent oxidation of the base material 10. During the welding of the weld nut 100 to the hot stamping molded article of high tensile steel, the welding quality and the deposition strength may be improved. Accordingly, the insertion component 120 may absorb the tightening torque, thereby maintaining the bonding strength of the welded portion 14.

Moreover, a contact area between the weld nut 100 and the base material 10 may be increased by the insertion component 120 having the predetermined portion inserted into the nut insertion aperture 12. Therefore, since a low current welding may be performed during welding the same volume, a generation of a spatter may be reduced. In particular, the incidence of bolting not being performed due to defect of the screw tap by the spatter may be prevented, thereby improving process quality.

Further, since the weld nut 100 may be more stably welded to the base material 10, water tightness (e.g., seal) between the base material 10 and the weld nut 100 may be secured. Additionally, although the exemplary embodiment describes the case in which the weld nut 100 is welded to the base material 10 by the welding by way of example, the present invention is not limited thereto. For example, in the case in which the bolt is mounted in the base material 10 by the welding, the inserting component may be integrally formed in a head component of the bolt that contacts the base material 10. In other words, the insertion component 120 according to an exemplary embodiment may be applied to the nut and the bolt.

While this invention has been described in connection with what is presently considered to be exemplary embodiments, it is to be understood that the invention is not limited to the disclosed exemplary embodiments. On the contrary, it is intended to cover various modifications and equivalent arrangements without departing from the spirit and scope as disclosed within the accompanying claims.

What is claimed is:

1. A weld nut welded to a base material through a nut insertion aperture formed in the base material, the weld nut comprising:
a nut body forming an appearance of the weld nut;
an insertion component that integrally protrudes from a first surface of the nut body and is inserted into the nut insertion aperture; and
a bolt fastening aperture that extends through the center of the nut body together with the insertion component.

2. The weld nut of claim 1, wherein the insertion component protrudes from the first surface of the nut body that has a thickness less than a thickness of the base material.

3. The weld nut of claim 1, wherein the insertion component is formed in a polygonal shape, an exterior peripheral surface of a protruded first end of the insertion component is rounded along a circumferential direction, and a second end of the insertion component connected to the nut body is slanted toward an exterior side of the nut body.

4. The weld nut of claim 1, wherein the insertion component is formed by a forging molding.

5. The weld nut of claim 1, wherein the bolt fastening aperture is formed vertically in a length direction of the nut body at the center of the nut body based on a width direction of the nut body at the center of the insertion part, and a screw tap is formed on an interior circumferential surface of the bolt fastening aperture.

6. The weld nut of claim 1, wherein the base material is a hot stamping molded boron steel plate.

7. The weld nut of claim 1, wherein the nut body is formed in a polygonal shape.

8. A weld nut welded to a base material at a position that corresponds to a nut insertion aperture formed in the base material and including a nut body forming an appearance, and a bolt fastening aperture formed to vertically extend through the nut body in a length direction of the nut body at the center based on a width direction of the nut body, the weld nut comprising:
an insertion component disposed within the nut insertion aperture and formed to integrally protrude from a first surface of the nut body to correspond to the nut insertion aperture.

9. The weld nut of claim 8, wherein the insertion component protrudes from the first surface of the nut body to have a thickness less than a thickness of the base material.

10. The weld nut of claim 8, wherein the insertion component is formed in a polygonal shape, an exterior peripheral surface of a protruded first end of the insertion component is rounded along a circumferential direction, and a second end of the insertion component connected to the nut body is slanted toward an exterior side of the nut body.

11. The weld nut of claim 8, wherein the insertion component is formed by a forging molding.

12. The weld nut of claim 8, wherein the bolt fastening aperture penetrates through the center of the insertion component and a screw tap is formed on an interior circumferential surface of the bolt fastening aperture.

13. The weld nut of claim 8, wherein the nut body has an appearance formed in a polygonal shape.

14. The weld nut of claim 8, wherein the base material is a hot stamping molded boron steel plate.
